(19) United States
(12) Patent Application Publication
(10) Pub. No.: US 2004/0177146 A1
(43) Pub. Date: Sep. 9, 2004

(54) Router apparatus, communication apparatus, network address management system, network address management method and network address management program

(75) Inventors: Masahiro Ishiyama, Tokyo (JP); Tatsuya Jimmei, Kanagawa (JP); Yuzo Tamada, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/742,866

(22) Filed: Dec. 23, 2003

(30) Foreign Application Priority Data
Feb. 25, 2003 (JP) 2003-047998

(51) Int. Cl. G06F 15/173; G06F 15/16

(52) U.S. Cl. 709/226; 709/230

(57) ABSTRACT

A network address management system includes a router, an address data storage device, a first communication apparatus and a second communication apparatus, and included in the router is a second connection request receiver, a second prediction unit and a determination unit. The second connection request receiver receives connection data, such as an MAC address for the second communication apparatus, and the second prediction unit employs the connection data for predicting an address while the determination unit determines whether the address is unique. When the predicted address is unique, the second communication apparatus skips duplicate address detection.

### RELATED APPLICATIONS

The present disclosure relates to the subject matter contained in Japanese Patent Application No. 2003-047998 filed on Feb. 25, 2003, which is incorporated herein by reference in its entirety.

### BACKGROUND OF The INVENTION

1. Field of the Invention

The present invention relates to a router apparatus for quickly performing duplicate address detection in an auto configuration system using IPv6, a communication apparatus, a network address management system, a network address management method and a network address management program.

2. Description of the Related Art

Currently, to execute applications via the Internet, various types of data links are employed, including those available with ATM, satellite and CATV systems, and the introduction has now begun of a new Internet Protocol, IPv6, for uniting such data links while providing a large memory capacity and a variety of usages.

On the Internet, each device is provided with an identifier, called an IP address, on which the exchange of data packets is based. For IPv6, an additional address auto configuration mechanism is provided, so that each device can automatically set an IP address without manpower being required. For the auto configuration of an address, a router employs multicast communication to notify a link, such as a segment or a sub-network, of the prefix of the IPv6 address that is managed for each interface of the router. A communication apparatus present in the same link receives this notification, and couples the IPv6 address of the interface of the communication apparatus with the received IPv6 address. To set a new IPv6 address, the communication apparatus must confirm that the IPv6 address allocated for the interface is not the same as that for another communication apparatus connected to the same link. According to RFC2462, Duplicate Address Detection (DAD) is defined as a confirmation procedure. For the duplicate address detection, the IPv6 employs a neighbor discovery protocol for automatically examining a link layer address, such as an MAC address, so that a collision is prevented between an IPv6 address for a new communication apparatus connected to the link and another one that is already present along the link. The duplicate address detection is described in detail in “RFC (Request For Comment: IPv6 Technical Standards Document”, Nos. 2461 and 2462, IPv6 Subcommittee.

However, for the duplicate address detection, after a packet requesting an examination is transmitted via a router to another link or site, whether a response to a duplicate address detection is to be received must be confirmed. That is, a fixed waiting period is required to confirm the detection of a duplicate address. Further, an IPv6 address that has been allocated cannot be employed until the duplicate address detection has been terminated.

The problem described above is a serious barrier for an apparatus, such as a portable telephone, whereby data are transmitted at high speed, via a network, while using an IPv6 address. That is, a new IPv6 address must be allocated for the apparatus each time there is a network change, and accordingly, each time an address is allocated, the duplicate address detection process must be performed. Therefore, packet exchange across a new network to which the apparatus has been moved and connected will not be performed immediately, and fast mobile communication will be prevented.

### SUMMARY OF The INVENTION

It is therefore an object of the invention is to provide a router apparatus for, as part of the IPv6 address auto configuration process, transmitting a notification for a case wherein duplicate address detection can be skipped, a communication apparatus, a network address management system, a network address management method and a network address management program.

In order to achieve the object, according to a first aspect of the invention, there is provided a router apparatus connected to a network and configured to transmit a packet received from a communication apparatus connected to the network to the destination of the packet, the router apparatus including: a receiving unit configured to receive information from the communication apparatus indicating that the communication apparatus is connected to the network; a storing unit configured to store the information received by the receiving unit; a predicting unit configured to predict an address used in the communication apparatus; a determining unit configured to determine whether or not the address predicted by the predicting unit collides with an address used in the network in accordance with the information previously stored in the storing unit; and a transmitting unit configured to transmit to the communication apparatus non-collision information indicating that the collision of the address has not occurred, in a case where the determining unit determines that the address predicted by the predicting unit does not collide with the address used in the network.

According to a second aspect of the invention, there is provided a communication apparatus including: a transmitting unit configured to transmit information indicating that the communication apparatus is connected to a network to a router apparatus connected to the network; a receiving unit configured to receive from the router apparatus non-collision information indicating that an address to be used in the communication apparatus is not collided in the network; and a setting unit configured to set the address for use in communicating in the network, in a case where the non-collision information is received by the receiving unit.

According to a third aspect of the invention, there is provided a network address management method for a communication system including a router apparatus and a communication apparatus both connected to a network, the method including: receiving information from the communication apparatus indicating that the communication apparatus is connected to the network; storing the information received by the receiving unit; predicting an address used in the communication apparatus; determining whether or not the address predicted collides with an address used in the network in accordance with the information previously stored; transmitting to the communication apparatus non-collision information indicating that the collision of the address has not occurred, in a case where determined that the address predicted does not collide with the address used in the network; and setting the address included in the collision-free information in the communication apparatus.

According to a fourth aspect of the invention, there is provided a network address management program product for causing a computer, which performs an address management on a network, to execute procedures including: receiving information from the communication apparatus indicating that the communication apparatus is connected to the network; storing the information received by the receiving unit; predicting an address used in the communication apparatus; determining whether or not the address predicted collides with an address used in the network in accordance with the information previously stored; and transmitting to the communication apparatus non-collision information indicating that the collision of the address has not occurred, in a case where determined that the address predicted does not collide with the address used in the network.

### BRIEF DESCRIPTION OF The DRAWINGS

The above objects and advantages of the present invention will become more apparent by describing in detail an exemplary embodiment thereof with reference to the accompanying drawings, wherein:

FIG. 1 is a diagram showing the overview of a network address management system according to one embodiment of the present invention;

FIG. 2 is a diagram showing the arrangement of a router apparatus;

FIG. 3 is a diagram showing the arrangement of a communication apparatus;

FIG. 4 is a diagram showing the structure of data for an IPv6 address;

FIG. 5 is a diagram showing data in a router solicitation message;

FIG. 6 is a diagram showing address prediction data;

FIG. 7 is a diagram showing data in an address list;

FIG. 8 is a diagram showing data in a router advertising message;

FIG. 9 is a diagram showing the processing for a network address management method;

FIG. 10 is a flowchart showing the operation of the router apparatus;

FIG. 11 is a flowchart showing a communication method used by the communication apparatus; and

FIG. 12 is a diagram showing a hash based address management table.

### DETAILED DESCRIPTION OF The PREFERRED EMBODIMENTS

Referring now to the accompanying drawings, a description will be given in detail of embodiments of the invention.

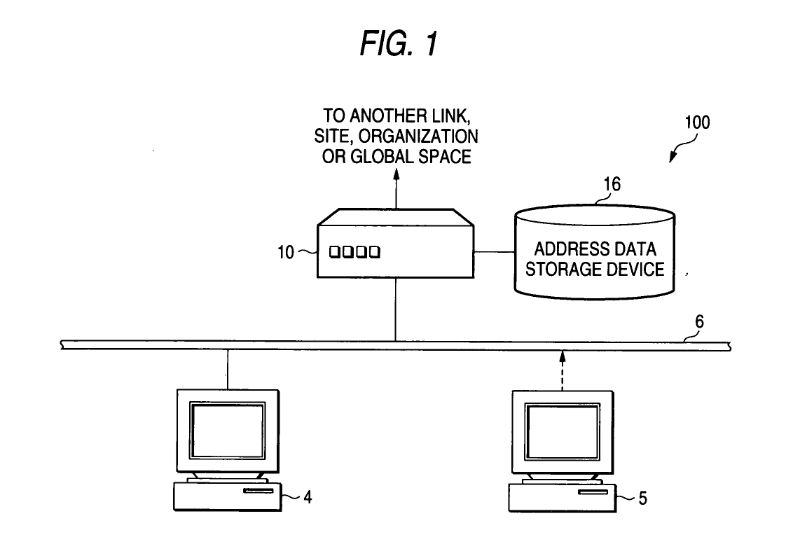

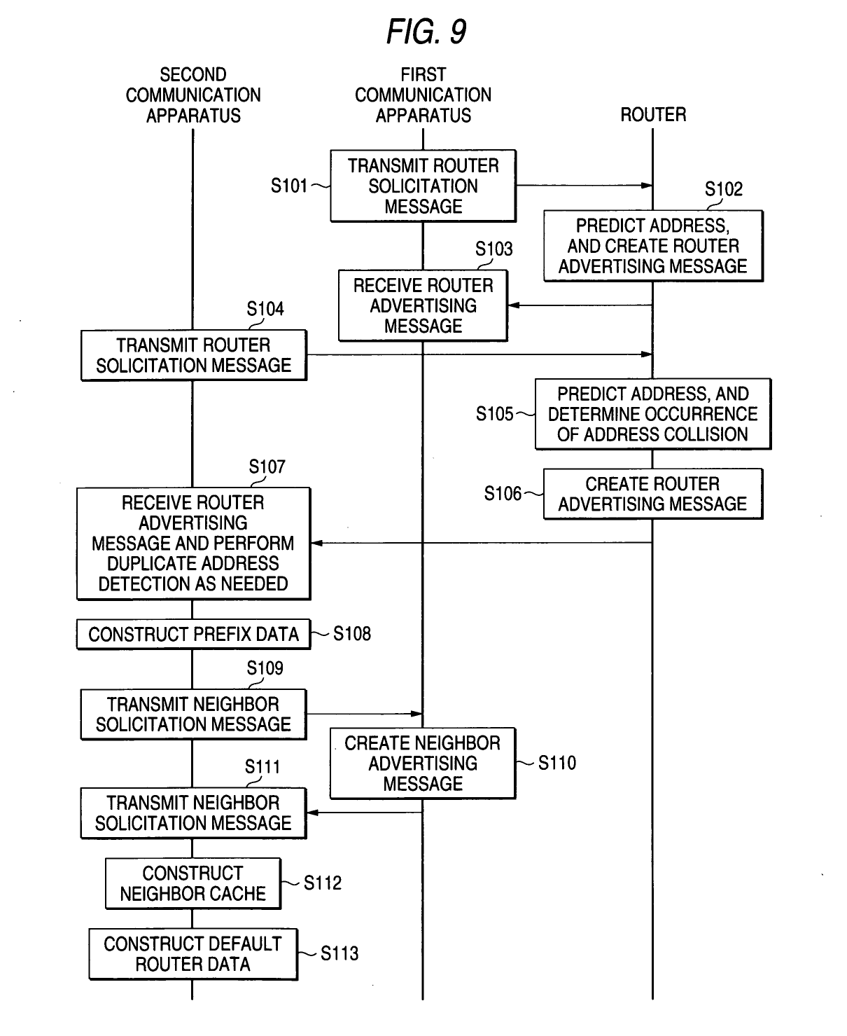

The neighbor discovery protocol for IPv6 is employed as a plug-and-play function for a so-called stateless auto configuration wherein for each link a link local address can be employed immediately after power is switched on. To perform this function, the IPv6 correlates its own multicast address, such as an MAC address, with a multicast address for a data link layer, and each communication apparatus automatically searches for a router. While referring to FIGS. 1 and 9, an explanation will be given for an overview of a network address management system and a network address management method for performing duplicate address detection through neighbor discovery using the IPv6 address. While in FIG. 1 the network address management system is connected to a wire, such as a LAN cable, the system can be applied for a mobile communication terminal, such as a portable telephone, using a wireless LAN or a wireless access network. Further, regardless of whether wire or wireless is used, the “network” represents a communication network, such as a link, a site, an organization or a global network, for transmitting data via a communication medium. In FIG. 1, a link managed by a router is employed for the explanation.

<Network Address Management System>

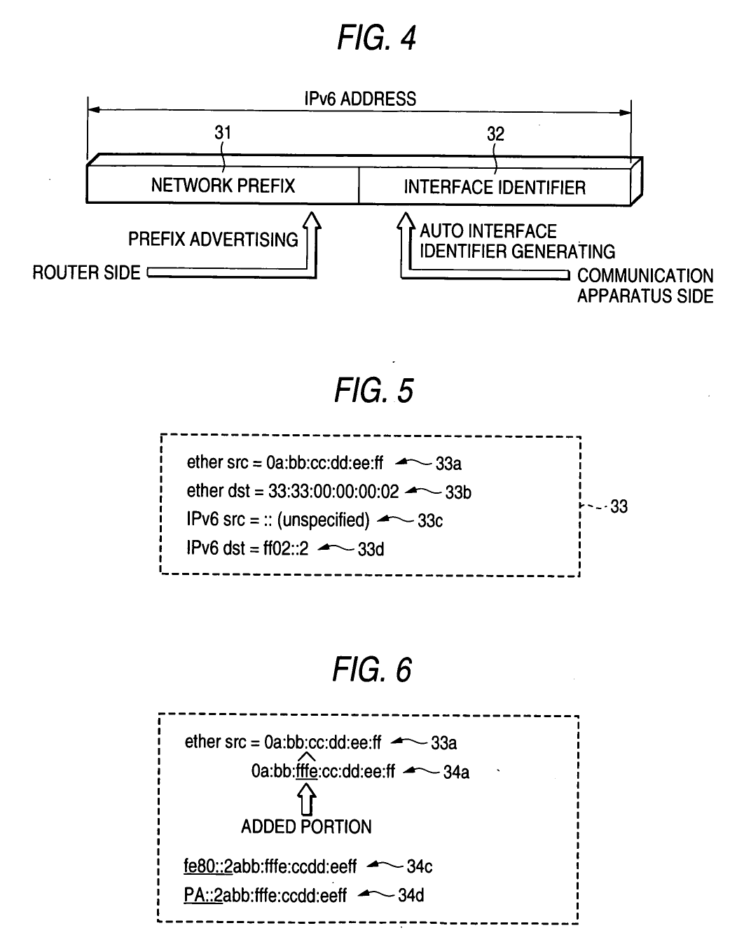

According to one embodiment of the invention, as is shown in FIG. 1, a network address management system 100 includes: a router 10, a first communication apparatus 4, a second communication apparatus 5 and a LAN cable 6 for connecting the router 10 to the first and second communication apparatuses 4 and 5. The router 10 is coupled with multiple other routers (not shown), and relays IP packets between the first and second communication apparatuses 4 and 5 and another communication network, such as a link, a site, an organization or a global network. The router 10 includes an address data storage device 16, for storing address data for the first and second communication apparatuses 4 and 5, and as is shown in FIG. 4, the address data is formed of a network prefix 31, which is a prefix advertisement for the router 10, and an interface identifier 32, which is automatically generated by the stateless function provided for the first and second communication apparatuses 4 and 5. It should be noted that the functions of the router 10 and the first and second communication apparatuses 4 and 5 are provided by installing, in a common computer, software programs that implement predetermined functions.

<Network Address Management Method>

While referring to FIG. 9, an explanation will be given for an overview of the operation of the network address management system 100 that employs the neighbor discovery protocol for the IPv6.

First, in step S101, the first communication apparatus 4, which is to be connected to a link via the LAN cable 6, transmits a router solicitation message to the router 10 using a multicast address. At this time, it is assumed that the first communication apparatus 4 is a communication apparatus that transmitted a first router solicitation message to the same link. In step S102, upon receiving the router solicitation message, the router 10 predicts a first address for the first communication apparatus 4 and stores the predicted address in the address data storage device 16. Since other predicted address data are not stored in the address data storage device 16, the router 10 transmits, to the first communication apparatus 4, a router advertising message that includes information indicating “no address collision (no duplicate address) is expected” and the predicted address. In step S103, the first communication apparatus 4 employs the received router solicitation message to initiate the connection with the network.

In step S104, as is shown in FIG. 9, the second communication apparatus 5, which is to be connected to the link via the LAN cable 6, transmits a router solicitation message to the router 10 using a multicast address. Instep S105, upon receiving the router solicitation message, the router 10 predicts a second address for the second communication apparatus 5 that has not yet been connected, and determines whether the second address will collide with the first address stored in the address data storage device 16. In step S106, when it is ascertained that no address collision (no duplicate address) is expected, the router 10 attaches the predicted second address to a router advertising message that includes information, required for the second communication apparatus 5, for establishing the connection with the link, and transmits the resultant router advertising message using a multicast address. It should be noted that the second address is stored in the address data storage device 16.

In step S107, upon receiving the router advertising message, the second communication apparatus performs the duplicate address detection process when it is ascertained that “an address collision may occur”, or when an address differing from the one predicted by the router 10 is to be allocated. In step S108, the second communication apparatus 5 employs the router advertising message to construct the prefix data for the router 10 for this link. The prefix data is a network prefix (network portion) that is router data included in the IPv6 address shown in FIG. 4.

In step S109, using a multicast address, the second communication apparatus 5 transmits a neighbor solicitation message to the first communication apparatus 4 present in the same link in order to request link layer data, such as an MAC address, that is unknown on the link. In step S110, the first communication apparatus 4 prepares and transmits a neighbor advertising message to the second communication apparatus 5.

When the second communication apparatus 5 receives the neighbor advertising message in step S111, the second communication apparatus 5 constructs, in step S112, a neighbor cache in which the received neighbor advertising message is confirmed and temporarily stored as a neighbor entry. In step S113, the second communication apparatus 5 constructs default router data used to search for a default path. In addition, the second communication apparatus 5 receives a redirect message from the router 10. Then, the second communication apparatus 5 thus connected to the link establishes a connection via the router 10 to a local site space or a global address space.

A detailed explanation will now be given for an apparatus and a method that are employed to determine in steps S105 and S106 whether the addresses used by the second communication apparatus 5 and the first communication apparatus 4 are collided.

<Router Apparatus>

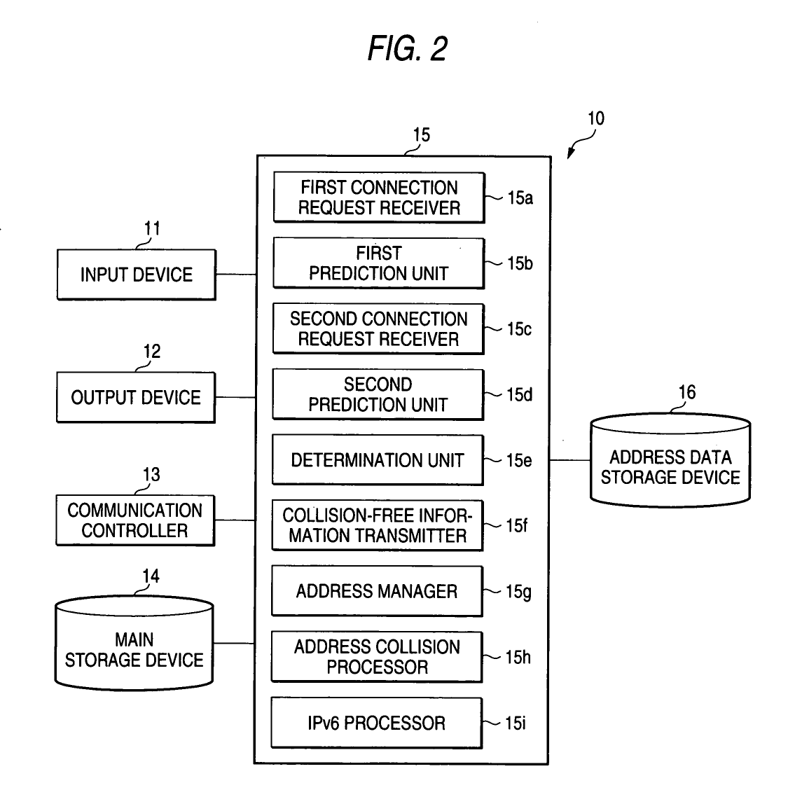

As is shown in FIG. 2, the router 10 includes: an input device 11, an output device 12, a communication controller 13, a main storage device 14, a CPU 15 and the address data storage device 16.

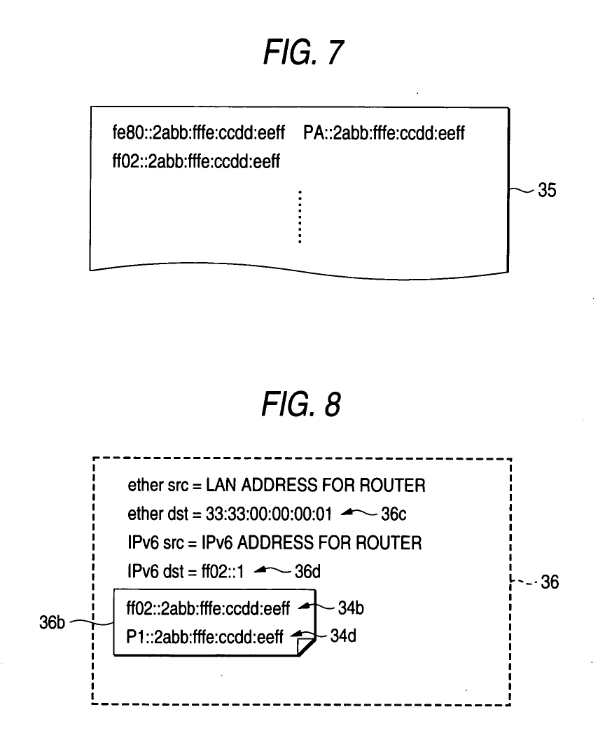

The address data storage device 16 stores the addresses of all the apparatuses, including the first and second communication apparatuses 4 and 5, that are connected to the LAN cable 6. Based on this data, an address list 35 shown in FIG. 7 is created.

The CPU 15 includes: a first connection request receiver 15a, a first prediction unit 15b, a second connection request receiver 15c, a second prediction unit 15d, a determination unit 15e, a collision-free information transmitter 15f, an address manager 15g, an address collision processor 15h and an IPv6 processor 15i. The first connection request receiver 15a is a module for receiving, for the first communication apparatus 4, first connection data for requesting a connection to the LAN cable 6, while the second connection request receiver 15c is a module for receiving, for the second communication apparatus 5, second connection data for requesting a connection to the LAN cable 6. Thus, the same operation is performed by the first connection request receiver 15a and the second connection request receiver 15c. The first prediction unit 15b is a module for employing the first connection data to predict and determine a first address to be used by the first communication apparatus 4, while the second prediction unit 15d is a module for employing the second connection data to predict a second address to be used by the second communication apparatus 5. Thus, the same operation is performed by the first prediction unit 15b and the second prediction unit 15d. The determination unit 15e is a module for employing information, including first address data, to determine whether, within the network, the second address is collided, while the collision-free information transmitter 15f is a module for transmitting information, including the second address, to the second communication apparatus 5 when the determination unit 15e ascertains that the second address is not collided, and the address manager 15g is a module for performing a process, which will be described in detail later, for updating the address data storage device 16. The address collision processor 15h is a module for notifying the second communication apparatus 5 when an address collision occurs, and the IPv6 processor 15i is a module for performing a next hop determination function and a redirect function that are unique to the IPv6.

The input device 11 is an interface for receiving a signal from the first and second communication apparatuses 4 and 5, while the output device 12 is an interface for transmitting a signal to the first and second communication apparatuses 4 and 5. Since the IPv6 address is provided for these interfaces and not for nodes, such as communication apparatuses, the interfaces can also hold the same link local address. The communication controller 13 generates a control signal to exchange a packet, via a wireless or wire communication line, with another node, such as another communication apparatus, and another router. In the main storage device 14, programs containing operating procedures are written or data to be processed are stored, and upon the reception of a request from the CPU 15, the machine instructions in the programs and the data stored in the main storage device 14 are transmitted. In addition, the data processed by the CPU 15 are written in the main storage device 14. It should be noted that the main storage device 14 and the CPU 15 are connected by an address bus, a data bus and a control signal bus.

<Network Address Management Method>

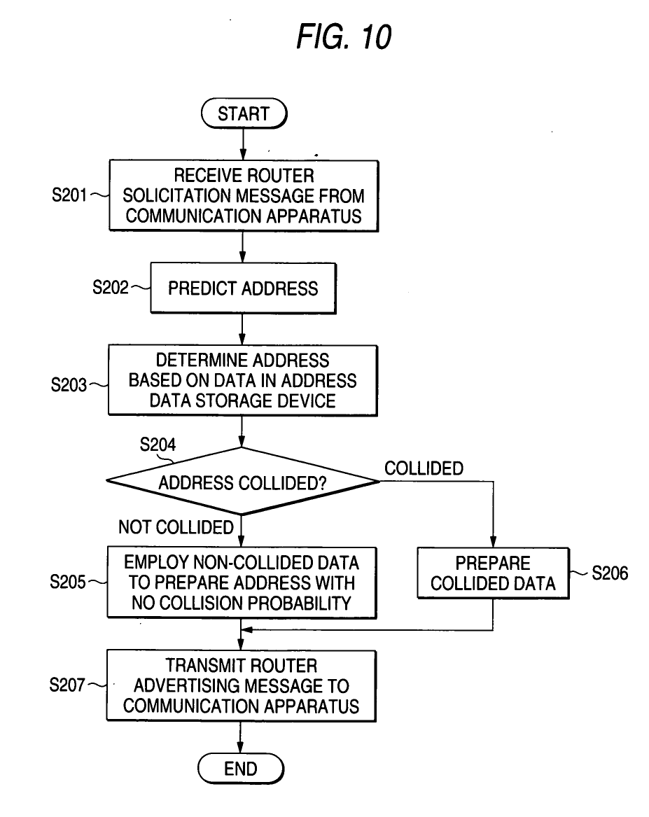

The operation of the router 10 in steps S10 and S106 will now be described in detail while referring to FIG. 10. The only differences between the first and the second communication apparatuses 4 and 5 are that the first communication apparatus 4 is connected to the network while the second communication apparatus 5 is disconnected from it, and it is assumed that the first address for the first communication apparatus 4 is stored in the address data storage device 16.

In step S201, the second connection receiver 15c receives a router solicitation message 33 for a multicast address, shown in FIG. 5, from the second communication apparatus 5 that requests the connection to the link via the LAN cable 6. In FIG. 5, a LAN, such as the ethernet (trademark) conforming to IEEE 802.3, is employed as a data link layer. A LAN transmission source address 33a is a 48 bit MAC address, created in accordance with an EUI-64 form, the first 24 bits of which represent a manufacturer identifier, and the remaining 24 bits represent a manufacturing identifier. The IPv6 is employed as a network layer, and a multicast address is employed as a LAN destination address 33b. The IPv6 transmission source address 33c is defined as “unspecified” (non-designated address) because at the current stage it is unknown. Furthermore, for an IPv6 destination address 33d, the network prefix address 31 in FIG. 4 is employed as “ff02::2”, which is a link-local all-router multicast address. The form of the first byte of the multicast address, such as an all router address or an all node address, is set in accordance with the relevant IPv6 specification.

In step S202, the second prediction unit 15d performs the address conversion. For this process, first, the second prediction unit 15d employs the LAN transmission source address 33a to generate the interface identifier 32 in FIG. 4. Specifically, as is shown in FIG. 6, “(Ox)fffe” is inserted between a manufacturer identifier “Oa:bb” and a manufacturing identifier “ccdd:eeff” for the LAN transmission source address 33a, and an interface identifier 34a is generated. Then, while the network prefix 31 is set to “fe80::”, a link local unicast address 34c is generated. Further, the identifier for a router, e.g., prefix “PA::”, advertised by the router A, is added to the network prefix 31, and an address 34d is generated. It is assumed that, for the addresses of the first communication apparatus 4 that are present on the link, an address list 35 in FIG. 7 has already been prepared.

In step S203, the determination unit 15e compares, with addresses in the address list 35, the generated addresses for the second communication apparatus 5, and determines whether an “address collision may occur”.

When it is ascertained in step S204 that there is no probability that an address collision will occur, in step S205, general router data for a router advertising message 36, in FIG. 8, and an address 36b that will not collide with another are immediately created. As is shown in FIG. 8, the LAN address for the router, multicast address “33:33:00:00:00:01”, which is the router destination address 36c, the IPv6 address for the router, and link local all-node multicast address “ff01::1”, which is the IPv6 destination address 36d for the router, are attached to the general router data. The address 36b, which will not collide with another address, includes the link local unicast address 34c and the address 34d that are predicted for the second communication apparatus 5, and is added either to the flag of the router advertising message 36 or to the extension header for a destination option. Further, the link local unicast address 34c and the address 34d for the router, which are predicted for the second communication apparatus 5, are newly entered in the address list 35 by the address management unit 15g. Thereafter, the collision-free information transmitter 15f transmits, to the second communication apparatus 5, the router advertising message to which the address 36b that will not collide with another is added (step S207). When it is ascertained that an address collision may occur, in step S206, the address collision processor 15h creates only the router general data, and transmits this data as the router advertising message 36, in FIG. 8, to the second communication apparatus 5 (step S207).

When the transmission source address of the router solicitation message is transmitted as “unspecified” and the router advertising message indicates that there is no possibility an address collision will occur, and when an address is to be allocated using an interface identifier that is not obtained from the MAC address used for the transmission of the router solicitation message, the second communication apparatus 5 must perform the duplicate address detection processing. In this case, after the router has transmitted the router advertising message, the router stores, in the address data storage device 16, the transmission source address for the second communication apparatus 5, which transmits the router solicitation message, and the list of the IPv6 addresses it is predicted will be allocated to the interface by the second communication apparatus 5.

The address of each communication apparatus that is predicted and generated by the router 10 can be obtained by using not only the link local address, but also by using the global address. Therefore, the same method can be employed to skip the duplicate address detection process, which each communication apparatus performs to obtain a global address.

According to the network address management method using the router 10, the link local unicast address and the link local multicast address, which are generated by the second prediction unit 15d, are compared with the addresses in the address list 35 to determine whether the duplicate address detection process should be performed, and a corresponding, appropriate process can be performed. Furthermore, when no address collision occurs, the duplicate address detection process need not be performed by the second communication apparatus 5, so that the waiting time is reduced. In addition, the address 36 that is attached to the router advertising message 36 and that does not cause an address collision can be immediately employed as an address, so that fast communication, using the plug-and-play function of the IPv6, and rapid shifting between networks can be performed.

<First Communication Apparatus and Second Communication Apparatus>

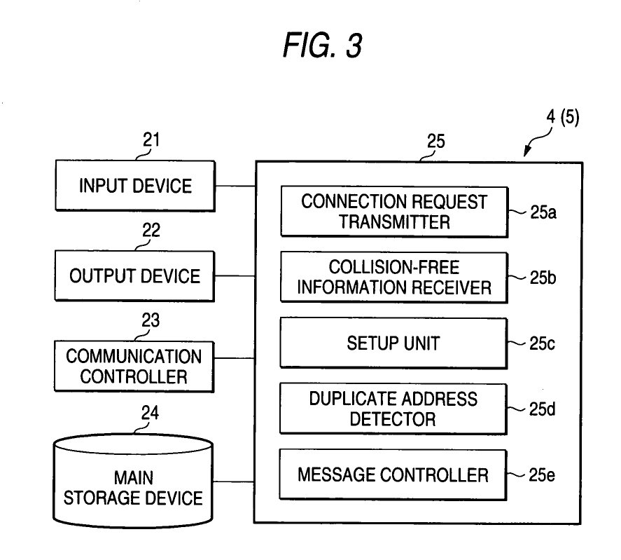

As is shown in FIG. 3, each of the first communication apparatus 4 and the second communication apparatus 5 includes an input device 21, an output device 22, a communication controller 23, a main storage device 24 and a CPU 25. The CPU 25 includes a connection request transmitter 25a, a collision-free information receiver 25b, a setup unit 25c, a duplicate address detector 25d and a message determination unit 25e. The connection request transmitter 25a is a module for transmitting to the router 10, via the network, the router solicitation message 33 in FIG. 5, which is connection data used for connecting to the network. The collision-free information receiver 25b is a module for receiving from the router 10, when it is ascertained that an address, generated based on the connection data, is not collided in the network, the router advertising message 36 in FIG. 8, which is collision-free information indicating that the pertinent address is not collided. The setup unit 25c is a module for setting the usage of the address after the router advertising message 36 has been received. The duplicate address detector 25d is a module for performing the duplicate address detection processing, and the message determination unit 25e is a module for determining whether the address 36d that will not collide with another is attached to the router advertising message 36. Since the input device 21, the output device 22, the communication controller 23 and the main storage device 24 are the same as those for the router 10, no further explanation for them will be given.

<Communication Method Employed By Second Communication Apparatus>

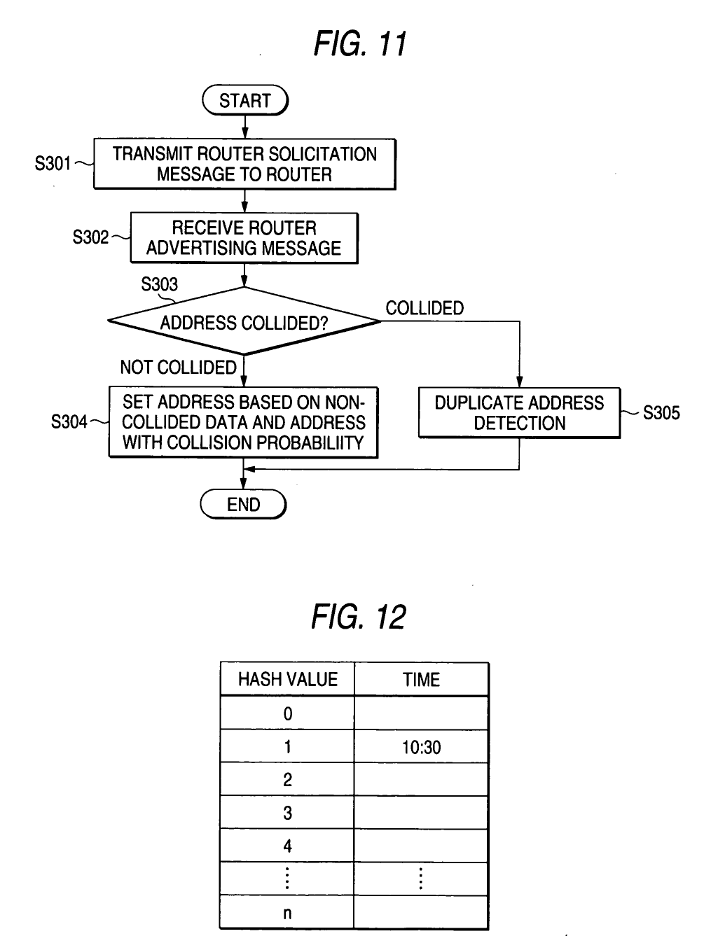

The operation of the second communication apparatus 5 in steps S104 and S107 in FIG. 9 will now be described while referring to the flowchart in FIG. 11.

In step S301, the connection request transmitter 25a transmits the router solicitation message 33 in FIG. 5 to the router 10 to request a connection to the LAN cable 6 in FIG. 1.

Upon receiving the router advertising message 36 in FIG. 8 in step S302, in step S303, the message determination unit 25e determines whether the address 36b that will not collide with another address is attached to the router advertising message 36. When the address 36b that will not collide with another is attached, in step S304, the collision-free information receiver 25b obtains this address 36b and the setup unit 25c sets it to perform communication via the router 10.

When the address 36b that will not collide with another is not attached, in step S305, the duplicate address detector 25d performs the normal duplicate address detection process.

Through the above described processing, when it is determined by the router 10 that the duplicate address detection by the second communication apparatus 5 is unnecessary, the waiting period during the duplicate address detection process can be eliminated. Further, since the address 36b that is received as an option and that will not collide with another can be immediately employed as an address, fast communication using the plug-and-play function of the IPv6, and the rapid shifting between networks can be performed.

<Example For Address Management>

As is shown in FIG. 2, the router 10 for this embodiment includes the address data storage device 16 and the address manager 15g for managing the address data. A supplemental explanation will now be given for the address management method.

The address manager 15g may employ various methods for storing data in the address data storage device 16 in order to determine the probability of an address collision. When a satisfactorily large area is prepared for storing addresses, all the addresses of the first communication apparatus 4 and the second communication apparatus 5 (hereinafter simply referred to as “communication apparatuses”) present on the same link may be entered, in a complete form of 128 bits, in a table created for each communication apparatus. When the address storage area of each communication apparatus is filled to a degree, the neighbor unreachability detection (NUD) function may be employed to determine whether the communication apparatuses are still in the same link. When the neighbor unreachability detection process is successful, i.e., when no communication apparatus having a specific address is present in the same link, this address can be deleted from the address list 35, or from the table that is prepared. The neighbor unreachability detection process can be performed, beginning with the communication apparatus that first received the router solicitation message and the neighbor solicitation message, by using the Last Recently Used (LRU) method for deleting a cache that has been employed least frequently. Then, the memory is cleared, and when a large free memory space is obtained, the process is terminated.

As a modification for the method described above, only the lower 64 bits of an address for each communication apparatus may be stored. To perform the neighbor unreachability detection function, all of the global local prefixes, the site local prefixes and the link local prefixes that can be employed for the current link are added to one address. When the address storage area for the table is not satisfactory, hashing may be performed for each address to obtain a hash value, and only this hash value may be stored. As an example, a hash base address management table (hereinafter referred to as an “HBAM table”) in FIG. 12 is prepared by using the hash function H8( ), whereby an eight bit hash value is obtained. An arbitrary hash value of 1 to h can be selected in accordance with the memory capacity of the address data storage device 16. When address A is detected, the value for H8(A) is obtained, and if the value is 1, the time, e.g., 10:30, is entered to the column “1” in the HBAM table. Then, upon receiving an inquiry for an address X from the communication apparatus, the address manager 15b obtains the value for H8(X) and examines the time on the HBAM table. When the value H8(X) is 2, since a corresponding time has not yet been entered in column “2” of the HBAM table, the address manager 15g assumes that the address X will not collide with any other address and transmits a response, “no collision probability”, to the communication apparatus. While upon receiving an inquiry for an address Y from the communication apparatus, the address manager 15g obtains the value for H8(Y) and examines the corresponding time on the HBAM table. When the value for H8(Y) is 1, since the corresponding time has already been entered in column 1 of the HBAM table, the address manager 15g assumes that the address Y probably will collide with another address and transmits a response, “a collision expected”, to the communication apparatus. The advantage of this method is that the probability of an address collision can be correctly determined by using a smaller storage area. However, since as the number of communication apparatuses is increased the HBAM table is filled, the probability is also increased that the address manager 15g will transmit a response, “collision expected”, even when an address will not actually collide with another.

Therefore, it is preferable that an HBAM table be refreshed (using deletion) when it has been filled to a degree. As a simple example method for accomplishing this, entries for which the recording times are very old are deleted for a network wherein communication apparatuses are frequently moved. Either this, or the HBAM table may be refreshed by periodically examining the presence of the communication apparatuses on the link. For this examination, an example method provides for the transmission of “icmp echo” (described in RFC792) to all the node link local multicast addresses.

A hash value may be obtained by only a part of an address, instead of the whole address. According to a method that uses the lower 64 bits of an address to obtain a hash value, a plurality of addresses can be employed for a link, such as a local link or a global link, wherein one node is present. In this case, since it is very probable that the lower 64 bits represent the same address, dispersion in the HBAM table can be prevented, and whether an address collision will occur can be efficiently determined. Furthermore, when old entries are not deleted from the HBAM table, bits of either 0 or 1 may simply be entered, instead of times. Using this method, a larger HBMA table having the same memory can be employed, compared with when times are entered. In addition, a method for storing complete addresses maybe employed first, and then, when the number of communication apparatuses connected to the link is increased, an HBAM table may be employed.

According to the invention, a router apparatus, a communication apparatus, a network address management system, a network address management method and a network address management program can be provided whereby, during an IPv6 address auto configuration process, notification can be obtained when a case is encountered wherein the duplicate address detection process can be skipped.

Although the present invention has been shown and described with reference to specific embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A router apparatus connected to a network and configured to transmit a packet received from a communication apparatus connected to the network to the destination of the packet, the router apparatus comprising:
a receiving unit configured to receive information from the communication apparatus indicating that the communication apparatus is connected to the network;
a storing unit configured to store the information received by the receiving unit;
a predicting unit configured to predict an address used in the communication apparatus;
a determining unit configured to determine whether or not the address predicted by the predicting unit collides with an address used in the network in accordance with the information previously stored in the storing unit; and
a transmitting unit configured to transmit to the communication apparatus non-collision information indicating that the collision of the address has not occurred, in a case where the determining unit determines that the address predicted by the predicting unit does not collide with the address used in the network.

2. The router apparatus as claimed in claim 1, wherein the address comprises IPv6 address, and
wherein the information received by the receiving unit comprises at least either of a neighbor solicitation packet and a router solicitation packet.

3. The router apparatus as claimed in claim 1, wherein the network comprises a data link layer of a IEEE 802.3 standard, and
wherein the information received by the receiving unit comprises a MAC address of the communication apparatus.

4. A communication apparatus comprising:
a transmitting unit configured to transmit information indicating that the communication apparatus is connected to a network to a router apparatus connected to the network;
a receiving unit configured to receive from the router apparatus non-collision information indicating that an address to be used in the communication apparatus is not collided in the network; and
a setting unit configured to set the address for use in communicating in the network, in a case where the non-collision information is received by the receiving unit.

5. The communication apparatus as claimed in claim 4, wherein the address comprises IPv6 address, and
wherein the transmitting unit transmits the information comprising at least either of a neighbor solicitation packet and a router solicitation packet.

6. The communication apparatus as claimed in claim 4, wherein the network comprises a data link layer of a IEEE 802.3 standard, and
wherein the transmitting unit transmits the information comprising a MAC address of the communication apparatus.

7. A network address management method for a communication system including a router apparatus and a communication apparatus both connected to a network, the method comprising:
receiving information from the communication apparatus indicating that the communication apparatus is connected to the network;
storing the information received by the receiving unit;
predicting an address used in the communication apparatus;
determining whether or not the address predicted collides with an address used in the network in accordance with the information previously stored;
transmitting to the communication apparatus non-collision information indicating that the collision of the address has not occurred, in a case where determined that the address predicted does not collide with the address used in the network; and
setting the address included in the collision-free information in the communication apparatus.

8. The network address management method as claimed in claim 7, wherein the address comprises IPv6 address, and
wherein the information received from the communication apparatus comprises at least either of a neighbor solicitation packet and a router solicitation packet.

9. The network address management method as claimed in claim 7, wherein the network comprises a data link layer of a IEEE 802.3 standard, and
wherein the information received from the communication apparatus comprises a MAC address of the communication apparatus.

10. A network address management program product for causing a computer, which performs an address management on a network, to execute procedures comprising:
receiving information from the communication apparatus indicating that the communication apparatus is connected to the network;
storing the information received by the receiving unit;
predicting an address used in the communication apparatus;
determining whether or not the address predicted collides with an address used in the network in accordance with the information previously stored; and
transmitting to the communication apparatus non-collision information indicating that the collision of the address has not occurred, in a case where determined that the address predicted does not collide with the address used in the network.
